(19) United States
(12) Patent Application Publication
(10) Pub. No.: US 2004/0038638 A1
(43) Pub. Date: Feb. 26, 2004

(54) Method and apparatus for at least stunning an animal for slaughter

(76) Inventor: Sander Antonie Van Ochten, Arnhem (NL)

Correspondence Address: John W Mcllvaine, 700 Koppers Building, 436 Seventh Avenue, Pittsburgh, PA, 15219-1818, US

(21) Appl. No.: 10/296,679

(22) PCT Filed: May 14, 2001
(86) PCT No.: PCT/NL01/00366

(30) Foreign Application Priority Data
May 30, 2000 (NL) 1015338

(51) Int. Cl. A22B 3/00

(52) U.S. Cl. 452/66

(57) ABSTRACT

The invention relates to a method for at least stunning an animal for slaughter, comprising two processing steps of: a) reducing the consciousness of the animal for slaughter. using a gas, and b) administering to the animal for slaughter with reduced consciousness at least one electrical pulse in order to influence the heart function of the animal for slaughter. The invention also relates to an apparatus for at least stunning an animal for slaughter, comprising: a gas stunning space with means for gas feed, and electrical stunning means.

The invention relates to a method for at least stunning an animal for slaughter, comprising two processing steps of: a) reducing the consciousness of the animal for slaughter using a gas, and b) administering to the animal for slaughter with reduced consciousness at least one electrical pulse in order to influence the heart fraction of the animal for slaughter. The invention also relates to an apparatus for at least stunning an animal for slaughter, comprising: a gas stunning space with meant for gas feed, and electrical stunning means.

At least stunning is understood to mean stunning such that slaughter can commence, generally by means of opening of the neck (also referred to as “sticking”), without adverse consequences for the meat quality and without impairing the welfare of the animal. Since the boundary between stunning and killing cannot be defined is unambiguously, at least stunning is understood to mean stunning or killing. At least stunning therefore includes, among others, physical conditions such as cardiac arrest, cardiac fibrillation, reduced brain function, brain death and so on. In the prior art animals for slaughter, and in particular large livestock such as pigs, cows, sheep etc., can be stunned using the stunning gas carbon dioxide (CO₂). For this purpose animals for slaughter are in practice placed for a time-span of one to one and a half minutes in a conditioned environment with a carbon dioxide concentration of practically 100%. The animals for slaughter which are then unconscious can subsequently be stuck. The drawbacks of this method are that the animals for slaughter usually display violent aversion responses to the stunning gas and muscle contractions occur during a stunning process, which has an adverse effect on the quality of the meat. As alternative to gas stunning, animals for slaughter are also stunned by means of a current pulse, wherein electrodes are placed for instance against the head or neck of the animal for slaughter. The drawback of this technique is that this can result, particularly in the case of manual, electrical stunning, in increased stress in animals for slaughter and there is less reliability that the stunning has actually taken place.

The German Gebrauchsmuster DE 299 21 214 describes an apparatus for stunning animals such as pigs, with a supply device for supplying the animals to a paternoster system and a discharge device for discharging the animals from this system. The paternoster lift comprises a cage construction, for instance in the form of a cradle, for accommodating at least one animal. The paternoster system moves in an environment conditioned with stunning gas in order to reduce the consciousness of the animals present in the system. The apparatus also comprises electrodes which are adapted for placing close to the heart region of the animals. Described in this publication as stunning gases are mixtures of CO₂ and a noble gas, preferably argons wherein the percentage by volume of CO₂, can rise to 30%.

The present invention has for its object to provide an improved method and apparatus for at least stunning animals for slaughter, whereby the above stated drawbacks can be obviated while the advantages of the prior art are retained. The method and apparatus according to the invention must further comply with a number of requirements in respect of animal welfare. An animal for slaughter must therefore not suffer any pain during the sticking and draining of blood (as a result of the sticking). This means in practice that the applied stunning must last for a minimum of 12 to 30 seconds after the sticking. After this time interval there will in any case be reduced consciousness because of loss of blood resulting from the sticking. It is found in practice that an animal for slaughter is usually only stuck a minute after leaving a stunning apparatus, which implies that it must be possible to guarantee the stunning for a minimum of up to one and a half minutes after leaving the stunning apparatus. The minimum duration is of great importance.

The invention provides for this purpose a method of the type stated in the preamble, characterized in that during the reduction in the consciousness of the animal for slaughter as according to processing step a) the animal for slaughter is placed in an environment with a gas containing at least 30% by volume, preferably at least 40% by volume of CO₂. Although it is not self-evident to carry out two successive processing steps when a stunning can also be brought about with a single operation. Journals for slaughter can be stunned in very controllable manner with the method according to the invention which results inter alia in a certain stunning of the processed animals for slaughter. The slaughtering process becomes more stable in that the time between influencing the heart function (“cardiac arrest”) and the sticking is less relevant; delays are permissible. The quality of the infliction of the sticking wound is also less critical. During the reduction of the consciousness of an animal for slaughter use can be made of a gas which has less adverse consequences for the meat quality than the gases used heretofore in gas stunning, without a greatly increasing period of time of an animal for slaughter in the gas-conditioned environment being necessary. It thus becomes possible with the said CO₂ content to achieve the desired stunning in a period of time of about one to one and a half minutes, which is an acceptable duration of time for an animal for slaughter to remain in a stunning gas. While no account is taken here of an extra-long time period to achieve more certainty in respect of the level of stunning of all animals for slaughter, it is precisely this over-long time period which is unnecessary in the application of the method according to the present invention. A stunning gas which is favourable in terms of animal welfare and the meat quality is thus combined with an acceptable length of the period of time of the animals for slaughter in the sty gas. Although it is also possible for this drawback to be obviated by two successive stunning phases in didn't stunning gases (a first “milder” gas and a second “stronger” gas), the drawback hereof is that mixing of the stunning gases has to be prevented. There may be some limited variation in the level of the reduced consciousness in animals for slaughter after progressing through processing step a) without this being disadvantageous, since a uniform level of at least stunning can be achieved with processing step b). The advantage hereof is that it is possible to work with a stunning gas which has a less negative influence on the meat quality, although such gases generally act less rapidly without a long time period in the milder gas being necessary. The remaining variation in the stunning level resulting from the gas stunning is in any case offset by processing step b). Furthermore, this processing step b) does not result in stress in the animals for slaughter since they already have a reduced consciousness at the start of processing step

In addition, it is recommended that during the reduction of consciousness of the animal for slaughter according to processing step a) the animal for slaughter is placed in an environment with a gas containing at least 15% by volume of O₂. It is possible by means of the method according to the invention to stun animals for slaughter with a CO₂O₂ mixture without it being necessary to proceed through a very prolonged stunning process for this purpose. The presence of a minimum concentration of O₂ has the advantage that the aversion responses and the muscle contractions of the animals for slaughter are hereby greatly reduced during processing step a) and that the meat quality (colour, drip-losses) is positively affected by this gas stunning. An additional aspect which can result in an enhanced meat quality is that the heart function is influenced at a moment when the oxygen concentration in the blood is increased.

The processing step b) can be performed after ending processing step a), but it is also possible for processing step b) to be performed while processing step a) is being performed and preferably some time after the commencement of processing step a). Processing step a) must after all have resulted in a reduced consciousness of the animal for slaughter before processing step b) can commence. Processing step b) must take place before the animal for slaughter fully regains consciousness, and this can be established with certainty when processing step b) is performed when the animal for slaughter is still located in the gas-conditioned environment. From practical considerations it may however be desired to perform the processing step b) only after the animal for slaughter has left a gas-filled space. The equipment with which the different processing steps are carried out can thus be placed one after the other and integration thereof is unnecessary. Another advantage of performing the processing steps successively is that processing step b) can be more readily controlled by an operator if this process takes place outside the gas-conditioned environment.

During processing step b) at least one electrical pulse is preferably administered for at least one second and with an amperage of at least one ampere. With such a current pulse the heart function of large livestock can be deregulated with a very high degree of reliability. In a preferred application at least one electrical pulse can thus be administered such that the heart of the animal for slaughter begins to fibrillate. The advantage of causing fibrillation of the heart is that the chance is very small that the heart function will return from this condition to a normal condition. It is however also possible to administer at least one electrical pulse such that the heart function of the animal for slaughter ceases. When the heart function of the animal for slaughter is measured, it is possible to adjust the electrical pulse to the specific heartbeat of the relevant animal, and furthermore it is then also possible to monitor the result of influencing the heart function.

The invention also provides an apparatus of the type stated in the preamble, characterized in that the gas stunning space is tunnel-shaped. With such an apparatus the method as described above can be carried out with all the associated advantages. Owing to the relatively short period of time of the animals for slaughter required in the stunning space, the stunning space can have a limited size (tunnel length) through which the animals for slaughter are carried. The logistics of the movement of the animals for slaughter are therefore much simpler than in the known combined gas/electric stunning apparatus of the German Gebrauchsmuster DE 299 21 214. The apparatus is preferably also provided with a conveyor for animals for slaughter which passes through the gas stunning space and connects onto the electrical stunning means. Using this conveyor the animals for slaughter can be carried through the gas stunning space irrespective of their degree of consciousness.

In a preferred embodiment the conveyor for animals for slaughter is assembled from a plurality of mutually connecting conveyor belts and/or the gas stunning space is constructed from connecting segments. By means of such a modular construction of the apparatus the production capacity can be varied and transport of the apparatus becomes simpler. The modular construction of the gas stunning space also independently forms part of this patent application.

In yet another preferred embodiment the means for gas feed and gas discharge are placed in the gas stunning space such that the gas flow is substantially perpendicular to a centre line through the tunnel-shaped gas stunning space. Owing to the tunnel shape and the volume of the installation the amount of stunning gas required can be limited and a gas flow can be generated in the stunning space in relatively simple manner. By arranging the gas flow perpendicularly of the centre line through the tunnel, preferably in the form of a gentle flow, the gas quality can be readily controlled everywhere in the tunnel. This can for instance be realized in that the gas feed means debouch close to the underside in the tunnel-shaped gas stunning space and the gas discharge means connect onto the tunnel-shaped gas stunning space close to the top. A vertically upward directed gas flow will hereby result in the tunnel-shaped gas stunning space. The gas flow substantially perpendicular to the centre line through a tunnel-shaped gas stunning space also independently forms part of this patent application.

The electrical stunning means can be disposed in the gas stunning space but it is also possible for the electrical stunning means to be disposed outside the gas stunning space and connecting onto an outlet opening from which the animals for slaughter leave the gas stunning space. The advantages of these two variants, a greater certainty in respect of the reduced consciousness against a simpler construction and operation of the apparatus, have already been described above.

In yet another preferred variant of the apparatus the means for gas feed also comprise circulation means for causing the stunning gas to flow in a direction opposed to a transport direction of the animals for slaughter through the gas stunning space. The quality of the stunning gas can be maintained by means of the circulation system. The stunning gas is administered efficiently and effectively owing to the counterflow direction of the gas relative to the transport direction of the animals for slaughter.

The invention also provides a method for supplying animals for slaughter to a slaughter line, wherein the animals for slaughter are displaced to a stunning device along at least two drive passages located a short distance from each other in a manner such that at least until shortly before commencement of the stunning process the animals for slaughter have a view of an adjacent drive passage. In preference the transporting speeds of the animals for slaughter along the drive passages are herein substantially the same and the drive passages run substantially parallel to each other. Using this method, wherein the animals can see each other and progress substantially parallel to each other during the supply to a slaughter line, the animals for slaughter can be carried in relatively calm manner to the slaughter line. The cause of the reduced stress in the parallel feed of animals for slaughter, in particular pigs, lies in the fact that the animals for slaughter have a preference for travelling in a group. The reduced stress in the animals results in an improved stunning quality which, in addition to an improved animal welfare (the animals are calmer), can result in an improvement of the meat quality. The method according to the invention also has the advantage that it can result in an increased utilization (a better filing) of a thus loaded slaughter line.

The invention further provides an apparatus for supplying animals for slaughter to a slaughter line, with at least two drive passages for animals for slaughter connecting onto the slaughter line, wherein the drive passages are in visual connection with each other, for instance in that the separation between the drive passages is formed by at least one tube. A preferred embodiment comprises a drive passage which connects onto a belly conveyor. The conveyor generally forms the beginning of a stunning device. A casing of a drive passage at the position of the entrance to the slaughter line is preferably substantially similar herein to a casing of the entrance to the slaughter line. This has the result that the transition from drive passage to slaughter line will not be perceived by the animals for slaughter, or will at least make so little impression that it will not result in increased stress in the animals for slaughter. Only at some distance beyond the infeed position of the animals onto the conveyor is it desirable to change the environment of the conveyor relative to the design of the drive passage. Such an apparatus can be realized in very simple manner and can be constructed from prior art components.

The present invention will be further elucidated with reference to the non-limitative embodiments shown in the following figures, wherein:

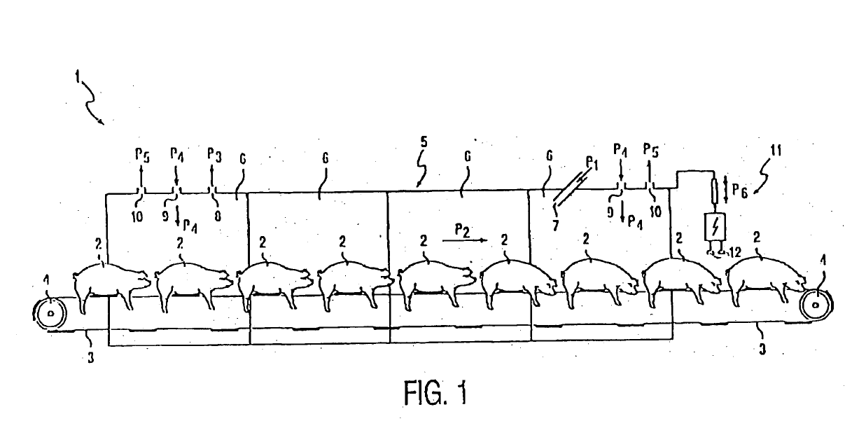

FIG. 1 shows a cut-away side view of an apparatus according to the invention,

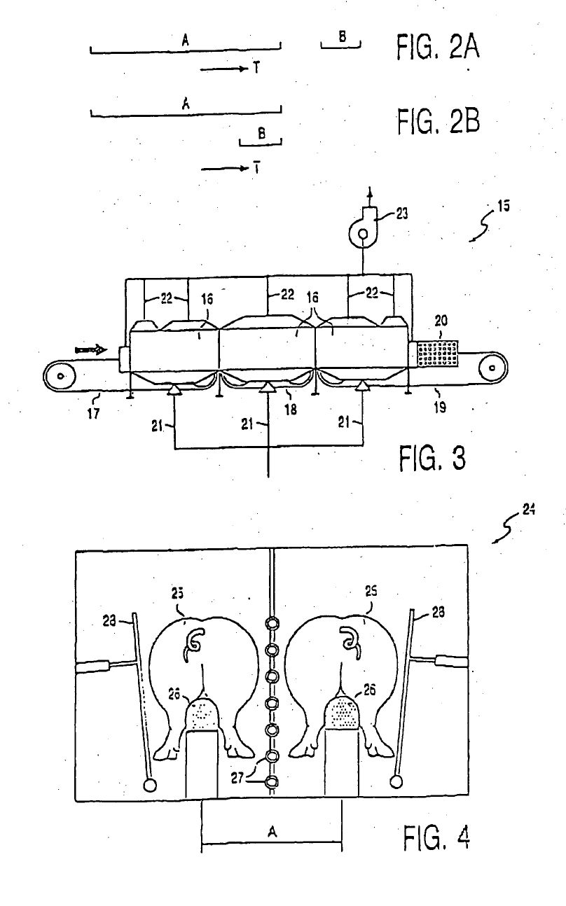

FIG. 2a is a schematic view of two successive processing steps,

FIG. 2b is a schematic view of two simultaneously performed processing steps,

FIG. 3 shows a schematic side view of an alternative embodiment of the apparatus according to the invention,

FIG. 4 shows a cross-section through an apparatus for supplying animals for slaughter to a slaughter line according to the present invention, and

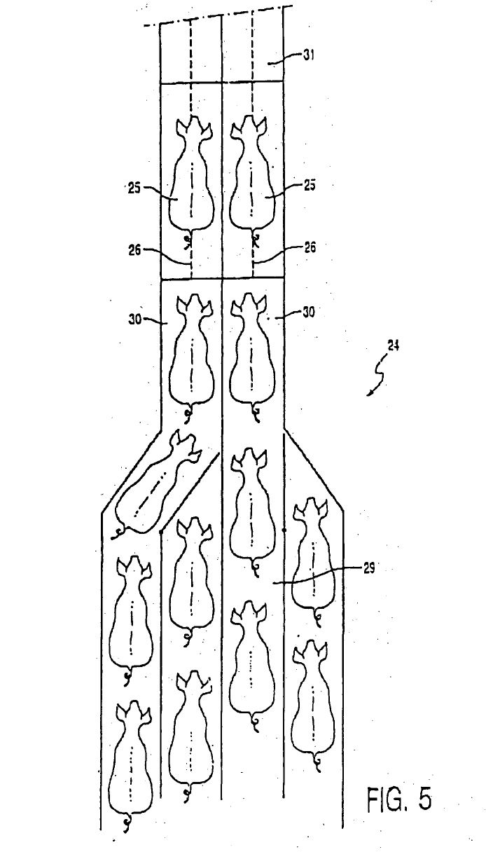

FIG. 5 shows a top view of the apparatus of FIG. 4.

FIG. 1 shows an apparatus 1 for at least stunning pigs 2. Pigs 2 are placed for this purpose on an endless belly conveyor 3 which is stretched between rotatable reversing rollers 4. During a first part of the path the pigs 2 are carried through a gas stunning space 5, which as stunning space 5 is constricted from segments 6. The segmented structure of gas stunning space 5 has the advantage that the length thereof can be readily modified and that the transport of gas stunning space 5 is thereby simplified. It will be possible in practice to vary the length of gas stunning space 5 between for instance 15 and 25 metres at a transport speed of the belly conveyor of between 0.15 and 0.4 metre/second. At a pitch of for instance 1.2 metres between the pigs, this will result in a capacity of respectively 450 and 1200 animals/hour. The pigs remain preferably for 1 to 1.5 minutes in gas stunning space 5. Gas which preferably contains at least 30% by volume and more preferably at least 40% by volume of CO₂ and at least 15% by volume of O₂ is blown in as according to arrow P1 through a feed pipe 7 for stunning gas. The flow direction of the stunning gas in gas stunning space 5 is in a direction substantially opposite to the direction of transport P2 of pigs 2. Close to the supply opening for pigs 2 in gas stunning space 5 is arranged a suction opening 8 for extracting as according to arrow P3 the stunning gas supplied by feed pipe 7. In order to prevent undesirable flow of stunning gas out of gas stunning space 5 there are provided two blow air openings 9, whereby air curtains can be generated as according to arrows P4. For the further safety of apparatus 1 there are also arranged safety suction openings 10 whereby air which may still contain a limited quantity of stunning gas can be extracted as according to arrows P5. Suction opening 8 can be connected to feed pipe 7 so as to thus create a circulation system for stunning gas. It will of course be necessary here to include a feed for stunning gas in the circulation system since the quality of the gas in stunning space 5 diminishes during, the passage, for instance due to the breathing of the pigs 2.

Electrical stunning means 11 are disposed downstream of the gas stunning space 5 in transport direction P2. Pigs 2 with a reduced consciousness are brought into contact with electrodes 12 which form part of stunning means 11 which are displaceable for this purpose as according to arrow P6. Electrodes 11 can transmit at least one electrical pulse, for instance with a 50-60 hertz alternating current, to a pig 2 such that the heart function of pig 2 is influenced. Pig 2 can then be further processed, for instance by sticking thereof.

FIG. 2a shows a schematic view of successive processing steps of a) reducing the consciousness of the animal for slaughter using a gas, and b) administering to the animal for slaughter with reduced consciousness at least one electrical pulse in order to influence the heart function of the animal for slaughter. The situation shown in his figure corresponds with the process as performed with the apparatus 1 show in FIG. 1.

FIG. 2b shows a schematic view of overlapping processing steps of a) reducing the consciousness of the animal for slaughter using a gas, and b) administering to the animal for slaughter with reduced consciousness at least one electrical pulse in order to influence the heart function of the animal for slaughter. The processing step b) is performed in the schematically shown situation while the animal for slaughter is still located in a gas conditioned space. Processing step b) can only be initiated once the consciousness of animal for slaughter has been reduced, i.e. only after processing step a) has been progressing for some time. The advantage hereof is that there is practically no chance of an animal for slaughter regaining consciousness shortly before commencement of processing step b).

FIG. 3 shows an apparatus 15 according to the invention of modular construction with tunnel segments 16 and three mutually connecting conveyor belts 17, 18, 19. Electrical stunning means 20 are shown schematically. Tunnel segments 16 are connected on the underside to feed conduits 21 for stunning gas. Connecting onto the top sides of the tunnel segments are discharge conduits 22 for stunning gas, whereby stunning gas is extracted from tunnel segments 16 by means of a pump 23. This extraction can for instance take place by means of a high volume/low pressure gas discharge. The flow direction of the stunning gas in apparatus 15 is therefore vertical and makes possible a good control of the quality of the stunning gas everywhere in apparatus 1.

FIG. 4 shows a cross-section through an apparatus 24 for supplying animals fr slaughter 25 to a slaughter line. The animals for slaughter 25 are displaced adjacently with belly conveyors 26, wherein they are only separated from each other by bars or tubes 27. Bars or tubes 27 form an open separation whereby the animals for slaughter 25 have a view of each other. The mutual distance A between the animals for slaughter 25 is preferably kept as small as possible. The freedom of movement of animals for slaughter 25 is limited by means of adjustable partitions 28. The stress which does occur when animals for slaughter 25 are displaced along a single drive passage is prevented by means of the parallel displacement of animals for slaughter 25.

FIG. 5 shows a top view of the apparatus 24 in which the animals for slaughter 25 are guided from a buffer station 29 to two parallel drive passages or passageways 30. Passageways 30 connect onto the belly conveyors 26 which lead to an entrance of a stunning device 31. The transition from belly conveyor 26 to stunning device 31 preferably has only a very small or no visual transition so as to cause minimum distress to the animals for slaughter 25.

Although the invention has been described with reference to only a few embodiments, it will be apparent to all that the present invention is by no means limited to the described and shown embodiments. On the contrary, many more variations are possible for the skilled person within the scope of the invention.

1. Method for at least stunning an animal for slaughter (2, 25), comprising two processing steps of:
a) reducing the consciousness of the animal for slaughter (2, 25) using a gas, and
b) administering to the animal for slaughter (2, 25) with reduced consciousness at least one electrical pulse in order to influence the heart function of the animal for slaughter (2, 25),
characterized in that during the reduction of the consciousness of the animal for slaughter (2, 25) as according to processing step a) the animal for slaughter (2, 25) is placed in an environment with a gas containing at least 30% by volume, preferably at least 40% by volume of CO₂.

2. Method as claimed in claim 1, characterized in that during the reduction of consciousness of the animal for slaughter (2, 25) according to processing step a) the animal for slaughter (2, 25) is placed in an environment with a gas containing at least 15% by volume of O₂.

3. Method as claimed in claim 1 or 2, characterized in that the processing step b) is performed after ending of processing step a).

4. Method as claimed in claim 1 or 2, characterized in that processing step b) is performed while processing step a) is being performed, and preferably some time after the commencement of processing step a).

5. Method as claimed in any of the foregoing claims, characterized in that at least one electrical pulse is administered for at least one second and with an amperage of at least one ampere.

6. Method as claimed in any of the foregoing claims, characterized in that at least one electrical pulse is administered such that the heart of the animal for slaughter (2, 25) begins to fibrillate.

7. Method as claimed in any of the foregoing claims, characterized in that at least one electrical pulse is administered such that the heart function of the animal for slaughter (2, 25) ceases.

8. Apparatus (1, 15) for at least stunning an animal for slaughter (2, 25). comprising: a gas stunning space (5) with means for gas feed (7, 21), and electrical stunning means (11, 20), characterized In that the gas stunning space (5) is tunnel-shaped.

9. Apparatus (1, 15) as claimed in claim 8, characterized in that the apparatus (1, 15) is also provided with a conveyor (3, 26) for animals for slaughter (2, 25) which passes through the gas stunning space (5) and connects onto the electrical stunning means (11, 20).

10. Apparatus. (1, 15) as claimed in claim 9, characterized in that the conveyor (3, 26) for animals for slaughter (2, 25) is assembled from a plurality of mutually connecting conveyor belts (17, 18, 19).

11. Apparatus (1, 15) as claimed in any of the claims 8-10, characterized in that the gas stunning space (5) is constricted from connecting segments (6, 16).

12. Apparatus (1, 15) as claimed in any of the claims 8-11, characterized in that the means for gas feed (7, 21) and gas discharge (8, 22) are placed in the gas stunning space (5) such that the gas flow is substantially perpendicular to a centre line through the tunnel-shaped gas stunning space (5).

13. Apparatus (1, 15) as claimed in any of the claims 8-12, characterized in that the gas feed means (7, 21) debouch close to the underside in the tunnel-shaped gas stunning space (5) and the gas discharge means (8, 22) connect onto the tunnel-shaped gas stunning space (5) close to the top.

14. Apparatus (1, 15) as claimed in any of the claims 8-13, characterized in that the electrical stunning means (11, 20) are disposed in the gas stunning space (5).

15. Apparatus (1, 15) as claimed in any of the claims 8-13, characterized in that the electrical stunning means (11, 20) are disposed outside the gas stunning space (5) and connecting onto an outlet opening (8, 22) from which the animals for slaughter (2, 25) leave the gas stunning space (5).

16. Apparatus (1, 15) as claimed in any of the claims 8-15, characterized in that the means for gas feed (7, 21) also comprise circulation means for causing the stunning gas to flow in a direction opposed to a transport direction of the animal for slaughter (2, 25) through the gas stunning space (5).

17. Method for supplying animals for slaughter (2, 25) to a slaughter line, is characterized in that the animals for slaughter (2, 25) are displaced to a device (24) along at least two drive passages (30) located a short distance from each other in a manner such that at least until shortly before commencement of the stunning process the animals for slaughter (2, 25) have a view of an adjacent drive passage (30).

18. Method as claimed in claim 17, characterized in that the transporting speeds of the animal for slaughter (2, 25) along the drive passages (30) are substantially the same.

19. Method as claimed in claim 17 or 18, characterized in that the drive passages (30) run substantially parallel to each other.

20. Apparatus (24) for supplying animals for slaughter (2, 25) to a slaughter line, with at least two drive passages (30) for animals for slaughter (2, 25) connecting onto the slaughter line, characterized in that drive passages (30) are in visual connection with each other.

21. Apparatus (24) as claimed in claim 20, characterized in that the separation between the drive passages (30) is formed by at least one tube (27).

22. Apparatus (24) as claimed in claim 20 or 21, characterized in that a drive passage (30) comprises a passageway (30) which connects onto a belly conveyor (3, 26).

23. Apparatus (24) as claimed in any of the claims 20-22, characterized in that a casing of a drive passage (30) at the position of the enhance to the slaughter line is substantially similar to a casing of the entrance to the slaughter line.
